(19) United States
(12) Patent Application Publication
(10) Pub. No.: US 2026/0228521 A1
(43) Pub. Date: Aug. 6, 2026

(54) LEARNING DEVICE, PROGRAM, AND LEARNING METHOD

(71) Applicant: KONICA MINOLTA, INC., Tokyo (JP)

(72) Inventor: Takehiko SASHIDA, Hachioji-shi, Tokyo (JP)

(21) Appl. No.: 19/147,401

(22) PCT Filed: Oct. 12, 2023
(86) PCT No.: PCT/JP2023/037096

§ 371 Date: Jul. 11, 2025

(30) Foreign Application Priority Data
Jan. 13, 2023 (JP) 2023-004145

(51) Int. Cl. G06N 3/08

(52) U.S. Cl. CPC G06N 3/08

(57) ABSTRACT

A learning device includes a relearning part and a learning target layer determination part. The relearning part causes a deep learning model that has been learned using first domain data (see source domain data) to perform relearning using second domain data (see target domain data). The learning target layer determination part determines a layer of the deep learning model to be a target of the relearning based on nodes that are included in a layer of the deep learning model and activated by the first domain data or nodes that are included in a layer of the deep learning model and activated by the second domain data.

### TECHNICAL FIELD

The present invention relates to a learning device, a program, and a learning method related to relearning of a deep learning model.

### BACKGROUND ART

Patent Literatures 1 and 2 describe technologies on relearning (transfer learning) for adapting a deep learning model that has undergone learning in a certain area (data area or domain) to another area. Note that the learned, original area may be called a source domain and the area to be adapted may be called a target domain.

A machine learning device described in Patent Literature 1 includes a domain adaptation level determining unit, a learning layer determining unit, and a transfer learning unit. The domain adaptation level determining unit determines a domain adaptation level based on inference accuracy when inferring an image of a second domain using a first model of a neural network that has been learned using images of a first domain as training data. The learning layer determining unit determines, based on the domain adaptation level, a learning target layer of a second model obtained by duplicating the first model. The transfer learning unit performs transfer learning on the learning target layer of the second model using the image of the second domain as training data.

The machine learning device described in Patent Literature 2 includes a domain adaptation data adequacy determination unit, a learning layer determining unit, and a transfer learning unit. The domain adaptation data adequacy determination unit determines a domain adaptation data adequacy based on the number of pieces of training data of a second domain when a first model of a neural network learned using training data of a first domain is transferred and learned using training data of the second domain. The learning layer determining unit determines, based on the domain adaptation data adequacy, a learning target layer of a second model that is a duplicate of the first model. The transfer learning unit performs transfer learning on a learning target layer of the second model by using training data of the second domain.

### CITATION LIST

### Patent Literature

Patent Literature 1: Japanese Unexamined Patent Application Publication No. 2022-085356
Patent Literature 2: Japanese Unexamined Patent Application Publication No. 2022-122326

### SUMMARY OF INVENTION

### Technical Problem

In the machine learning device described in Patent Literature 1, the domain adaptation level is determined based on the inference accuracy to determine the learning target layer, but the device is based on the premise that the source domain and the target domain overlap (include images of the same type). The machine learning device described in Patent Literature 2 determines the domain adaptation data adequacy based on the number of pieces of training data to determine the learning target layer, but sufficient accuracy may not be obtained because the magnitude of a difference between domains is not sufficiently considered.

In a deep learning model, in a case where a difference between the source domain and the target domain is large, accuracy is considered to improve by performing relearning including not only an identification layer but also a feature extraction layer at a stage when a certain amount of data of the target domain has been collected. However, there is a problem in that setting of an appropriate learning condition must rely on the intuition and experience of a skilled person.

The present invention has been made in view of the above circumstances, and an object thereof is to provide a learning device, a program, and a learning method that enable effective relearning of a deep learning model.

### Solution to Problem

The above-described object of the present invention is achieved by the following means.
(1) A first aspect of the present invention provides a learning device, including a relearning part and a learning target layer determination part. The relearning part is configured to cause a deep learning model that has been learned using first domain data to perform relearning using second domain data. The learning target layer determination part is configured to determine a layer of the deep learning model to be a target of the relearning based on nodes that are included in a layer of the deep learning model and activated by the first domain data or nodes that are included in a layer of the deep learning model and activated by the second domain data.
(2) A second aspect of the present invention provides the learning device according to the first aspect, further including a feature amount activity level distribution calculation part. The feature amount activity level distribution calculation part is configured to calculate a feature amount activity level distribution that is a distribution of activity levels of nodes according to inputted domain data, the nodes being included in a predetermined layer of the deep learning model. The learning target layer determination part is configured to: determine, in response to a difference between the feature amount activity level distribution when the first domain data is input and the feature amount activity level distribution when the second domain data is input being within a predetermined range, only an identification layer of the deep learning model as the layer to be the target of the relearning; and determine, in response to the difference not being within the predetermined range, the identification layer and a layer of the deep learning model that is closer to an input side than the identification layer as the layer to be the target of the relearning.
(3) A third aspect of the present invention provides the learning device according to the first aspect, further including an active feature amount calculation part. The active feature amount calculation part is configured to calculate an activated feature amount that is a set of nodes that are included in a predetermined layer of the deep learning model and whose activation levels according to inputted domain data are greater than or equal to a predetermined value. The learning target layer determination part is configured to: determine, in response to a difference between the activated feature amount when the first domain data is input and the activated feature amount when the second domain data is input being within a predetermined range, only an identification layer of the deep learning model as the layer to be the target of the relearning; and determine, in response to the difference not being within the predetermined range, the identification layer and a layer of the deep learning model that is closer to an input side than the identification layer as the layer to be the target of the relearning.
(4) A fourth aspect of the present invention provides the learning device according to the first aspect, further including an active feature amount coverage calculation part. The active feature amount coverage calculation part is configured to calculate a coverage that is a proportion of nodes that are included in a predetermined layer of the deep learning model and whose activation levels according to inputted domain data are greater than or equal to a predetermined value to nodes included in the predetermined layer. The learning target layer determination part is configured to: determine, in response to a difference between the coverage when the first domain data is input and the coverage when the second domain data is input being within a predetermined range, only an identification layer of the deep learning model as the layer to be the target of the relearning; and determine, in response to the difference not being within the predetermined range, the identification layer and a layer of the deep learning model that is closer to an input side than the identification layer as the layer to be the target of the relearning.
(5) A fifth aspect of the present invention provides a learning device according to any one of the second, third, or fourth aspect, in which the learning target layer determination part is configured to determine that, the greater a degree by which the difference falls outside the predetermined range is, the more layers of the deep learning model that are close to an output layer, including the identification layer, are to be the layer to be the target of the relearning.
(6) A sixth aspect of the present invention provides a learning device according to any one of the second, third, or fourth aspect, further including a display control part configured to display a relearning condition confirmation screen on which the difference and a number of the layers to be the target of the relearning are indicated.
(7) A seventh aspect of the present invention provides the learning device according to the first aspect, further including a feature amount activity level distribution calculation part configured to calculate a feature amount activity level distribution that is a distribution of activity levels of nodes according to the second domain data, the nodes being included in a predetermined layer of the deep learning model. The learning target layer determination part is configured to: determine, in response to an amount of change in the feature amount activity level distribution with an increase in a data amount of the second domain data used to relearn an identification layer of the deep learning model being within a predetermined range, only the identification layer of the deep learning model as the layer to be the target of the relearning; and determine, in response to the amount of change not being within the predetermined range, the identification layer and a layer of the deep learning model that is closer to an input side than the identification layer as the layer to be the target of the relearning.
(8) An eighth aspect of the present invention provides the learning device according to the first aspect, further including an inference accuracy calculation part configured to calculate an inference accuracy of the deep learning model after the relearning regarding second domain data. The learning target layer determination part is configured to: determine, in response to an amount of change in the inference accuracy with an increase in a data amount of the second domain data used to relearn an identification layer of the deep learning model being within a predetermined range, only the identification layer of the deep learning model as the layer to be the target of the relearning; and determine, in response to the amount of change not being within the predetermined range, the identification layer and a layer of the deep learning model that is closer to an input side than the identification layer as the layer to be the target of the relearning.
(9) A ninth aspect of the present invention provides the learning device according to the first aspect, further including an active feature amount calculation part configured to calculate an activated feature amount that is a set of nodes that are included in a predetermined layer of the deep learning model and whose activation levels according to the second domain data are greater than or equal to a predetermined value. The learning target layer determination part is configured to: determine, in response to an amount of change in the activated feature amount with an increase in a data amount of the second domain data used to relearn an identification layer of the deep learning model being within a predetermined range, only the identification layer of the deep learning model as the layer to be the target of the relearning; and determine, in response to the amount of change not being within the predetermined range, the identification layer and a layer of the deep learning model that is closer to an input side than the identification layer to be the layer to be the target of the relearning.
(10) A tenth aspect of the present invention provides the learning device according to the first aspect, further including an active feature amount coverage calculation part configured to calculate a coverage that is a proportion of nodes that are included in a predetermined layer of the deep learning model and whose activation levels according to the second domain data are greater than or equal to a predetermined value to nodes included in the predetermined layer. The learning target layer determination part is configured to: determine, in response to an amount of change in the coverage with an increase in a data amount of the second domain data used to relearn an identification layer of the deep learning model being within a predetermined range, only the identification layer of the deep learning model as the layer to be the target of the relearning; and determine, in response to the amount of change not being within the predetermined range, the identification layer and a layer of the deep learning model that is closer to an input side than the identification layer to be the layer to be the target of the relearning.
(11) An eleventh aspect of the present invention provides a learning device according to any one of the seventh, eighth, ninth, or tenth aspect, in which when the amount of change is not within the predetermined range, the learning target layer determination part is configured to determine that the greater a degree by which the amount of change falls outside the predetermined range is, the more layers of the deep learning model that are closer to the input side than the identification layer and close to an output layer are to be the layer to be the target of the relearning.
(12) A twelfth aspect of the present invention provides the learning device according to the first aspect, in which a data amount of the second domain data is equal to or less than 1/100 of a data amount of the first domain data.
(13) A thirteenth aspect of the present invention provides a program for causing a computer to perform operations including: causing a deep learning model that has been learned using first domain data to perform relearning using second domain main data; and determining a layer of the deep learning model to be a target of the relearning based on nodes that are included in a layer of the deep learning model and activated by the first domain data or nodes that are included in a layer of the deep learning model and activated by the second domain data.
(14) A fourteenth aspect of the present invention provides a learning method performed by a learning device. The learning method includes: causing a deep learning model that has been learned using first domain data to perform relearning using second domain data; and determining a layer of the deep learning model to be a target of the relearning based on nodes that are included in a layer of the deep learning model and activated by the first domain data or nodes that are included in a layer of the deep learning model and activated by the second domain data.

### Advantageous Effects of Invention

According to the present invention, it is possible to provide a learning device, a program, and a learning method that enable effective relearning of a deep learning model.

### BRIEF DESCRIPTION OF DRAWINGS

FIG. 1 is a functional block diagram of a learning device according to a first embodiment.

FIG. 2 is a diagram for explaining a configuration of a deep learning model according to the first embodiment.

FIG. 3 is a configuration diagram of a relearning condition confirmation screen according to the first embodiment.

FIG. 4 is a flowchart of relearning processing according to the first embodiment.

FIG. 5 is a functional block diagram of a learning device according to a second embodiment.

FIG. 6 is a functional block diagram of a learning device according to a third embodiment.

FIG. 7 is a configuration diagram of a relearning condition confirmation screen according to the third embodiment.

FIG. 8 is a flowchart of relearning processing according to the third embodiment.

FIG. 9 is a functional block diagram of a learning device according to a fourth embodiment.

### DESCRIPTION OF EMBODIMENTS

### Outline of Learning Device

A learning device according to an embodiment of the present invention will be described below. The learning device calculates a feature amount activity level distribution that is a distribution of activity levels of nodes (neurons) included in a deep learning model. The learning device calculates the feature amount activity level distribution when data of a source domain is input and the feature amount activity level distribution when data of a target domain is input, and acquires a difference. When the difference is small, the learning device sets only an identification layer of the deep learning model as a target of relearning. When the difference is large, the learning device sets the identification layer and a feature extraction layer (a layer that is closer to an input side than the identification layer) as relearning targets. As the difference increases, more layers from the feature extraction layer are set as relearning targets starting from a layer closest to the identification layer.

According to such a learning device, in a case where the source domain and the target domain are similar and feature amounts of input data are sufficiently extracted, a deep learning model having a high identification accuracy (classification accuracy, estimation accuracy) may be obtained as a result of relearning even when an amount of data of the target domain is small. In a case where the source domain and the target domain are not similar to each other and extraction of feature amounts of the input data is insufficient, by improving the extraction of the feature amounts of the input data, improvement in the identification accuracy of the deep learning model after relearning may be expected.

### Configuration of Learning Device

FIG. 1 is a functional block diagram of a learning device 100 according to a first embodiment. The learning device 100 is a computer and includes a controller 110, a storage 130, and an input/output part 180. The input/output part 180 is connected to a user interface device such as a display, a keyboard, or a mouse. The input/output part 180 may include a communication device so as to be able to transmit and receive data to and from another device. Furthermore, a media drive may be connected to the input/output part 180 so that data may be exchanged using a non-transitory recording medium.

### Learning Device: Storage

The storage 130 includes a storage device such as a read only memory (ROM), a random access memory (RAM), or a solid state drive (SSD). The storage 130 stores therein source domain data 140, target domain data 150, a learning model database 160, and a program 138. The program 138 includes a description of a procedure of relearning processing (see FIG. 4) to be described later.

The source domain data 140 (first domain data) stores therein training data used for generation (learning, training) of a deep learning model before relearning, which is stored in the learning model database 160 described later. The training data includes input data (e.g., an image) and output data (a correct label) of the deep learning model.

The target domain data 150 (second domain data) includes training data (input data and output data) of a data area to which the deep learning model is to be applied. An example of a data area (source domain) that includes input data before relearning consists of images of general objects including an animal, furniture, or equipment. Examples of a data area (target domain) that includes input data of a destined application consists of satellite images, medical images, and photomicrographs.

As described above, the source domain and the target domain are different domains. As another example of different domains in an image domain, there is an example in which the source domain consists of general scenery images while the target domain consists of X-ray CT images. In the case of a language domain, there is an example in which the source domain consists of general sentences while the target domain consists of legal documents. In the case of a voice domain, there is an example in which languages are different for the source domain and the target domain.

The learning model database 160 stores therein a deep learning model before relearning that is generated (trained) using the training data in the source domain data 140. Furthermore, the learning model database 160 stores therein a deep learning model obtained as a result of the generated deep learning model going through relearning (retraining) using the training data in the target domain data 150.

### Configuration of Deep Learning Model

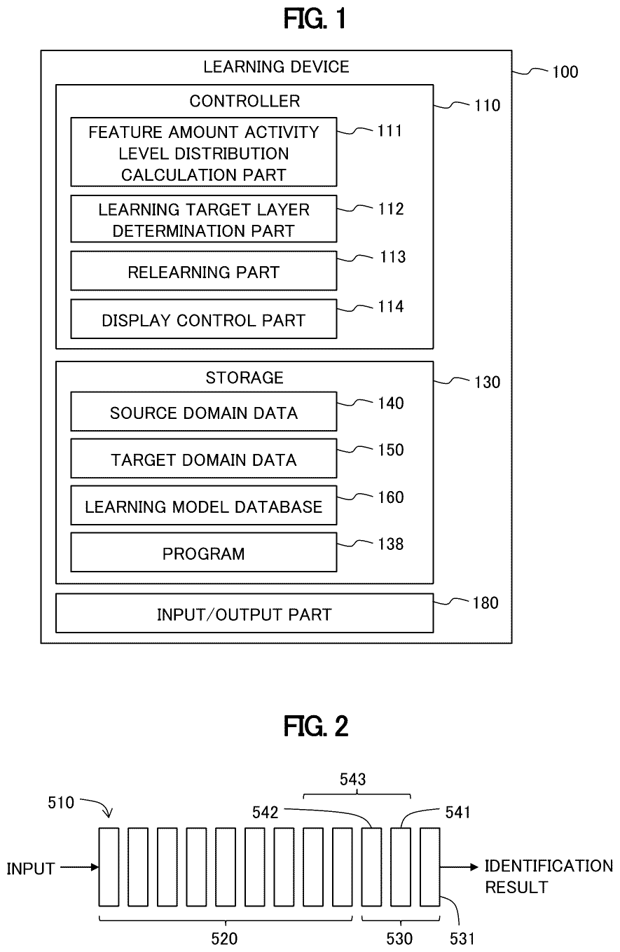

FIG. 2 is a diagram for explaining a configuration of a deep learning model 510 according to the first embodiment. The deep learning model 510 is one of a neural network, and is configured to include a feature extraction layer 520 and an identification layer 530. Each layer of the feature extraction layer 520 and the identification layer 530 includes a node (neuron). When input data is given, the data is sequentially processed by layers included in the deep learning model 510 from a layer on the left side towards a layer on the right side. An activity level of the node included in an output layer 531 that is the last layer becomes output data (identification result).

The feature extraction layer 520 is a function block that is close to an input and generates a feature by using a convolution layer or the like. The identification layer 530 is close to an output, and is a function block that solves a problem (e.g., performs classification or inference) from the features generated by the feature extraction layer 520 by using a fully connected layer or the like.

Note that the deep learning model 510 itself is a set of parameters and not an entity that processes data. However, because processing is performed in accordance with the parameters, description may be given in which the deep learning model 510 itself is described as processing the data. For example, the deep learning model 510 may be described as detecting an object appearing in an inputted image and outputting the object as an identification result.

As an example of the deep learning model 510, VGG16 used for image identification is known. The feature extraction layer 520 of the VGG16 includes 13 convolution layers, and the identification layer 530 of the VGG16 includes three layers of fully connected layers. A configuration in which the deep learning model 510 includes the feature extraction layer 520 and the identification layer 530 is one example. The deep learning model 510 may be configured to include the identification layer and another layer (a layer closer to an input side [the left side in FIG. 2] than the identification layer).

### Learning Device: Controller

Referring back to FIG. 1, the controller 110 will be described. The controller 110 is configured to include a central processing unit (CPU) and includes a feature amount activity level distribution calculation part 111, a learning target layer determination part 112, a relearning part 113, and a display control part 114. The controller 110 may be configured using a graphics processing unit (GPU), a field programmable gate array (FPGA), an application specific integrated circuit (ASIC), or the like.

### Controller: Feature Amount Activity Level Distribution Calculation Part

The feature amount activity level distribution calculation part 111 calculates feature amount activity level distributions of input data (for example, image data) included in the source domain data 140 and the target domain data 150. The feature amount activity level distribution of input data is a distribution of activity levels of nodes included in a feature amount calculation target layer of the deep learning model 510 when the input data is input. The feature amount calculation target layer is, for example, a layer 541 that is one layer before (closer to the input side) the output layer 531 (see FIG. 2). The feature amount calculation target layer may be layers 541 and 542, which further includes a layer 542 that is one layer before the layer 541. The feature amount calculation target layer may be a predetermined number of layers 543 that are before the output layer 531.

An amount of input data and the number of nodes included in the feature amount calculation target layer are large, and the feature amount activity level distribution becomes a distribution in a multidimensional space of a large degree. For this reason, a method such as t-SNE may be used to embed the feature amount activity level distribution into a low-dimensional space. For example, the feature amount activity level distribution calculation part 111 embeds the feature amount activity level distributions of the input data in the source domain data 140 and the target domain data 150 in a low-dimensional space, and calculates the respective feature amount activity level distributions for the input data in the source domain data 140 and the input data in the target domain data 150. The feature amount activity level distribution calculation part 111 may, instead of calculating a feature amount activity level distribution for all of the input data in the source domain data 140 or the target domain data 150, calculate a feature amount activity level distribution for a partial data. The partial data may for example be pieces of input data that have been randomly selected to form a predetermined proportion to the whole of the input data. The partial data may for example be a predetermined number of pieces of input data that have been randomly selected.

In the following description, the feature amount activity level distribution of the input data in the source domain data 140 may simply be referred to as the feature amount activity level distribution of the source domain data 140. Further, the feature amount activity level distribution of the input data in the target domain data 150 may be referred to as the feature amount activity level distribution of the target domain data 150.

As described above, the learning device 100 includes the feature amount activity level distribution calculation part 111 that calculates a feature amount activity level distribution. The feature amount activity level distribution is a distribution of activity levels of nodes by inputted domain data, where the nodes are nodes that are included in a predetermined layer of the deep learning model 510.

### Controller: Learning Target Layer Determination Part

The learning target layer determination part 112 determines a layer of the deep learning model 510 (see FIG. 2) to be a target of relearning based on the feature amount activity level distribution of the source domain data 140 and the feature amount activity level distribution of the target domain data 150. More specifically, when a difference between the two feature amount activity level distributions is within a predetermined range, the learning target layer determination part 112 sets only a layer included in the identification layer 530 as the target of relearning. When the difference is outside the predetermined range, the learning target layer determination part 112 sets more layers, starting from the output layer 531 and toward the input side (the left side in FIG. 2), as targets of relearning. The layers to be targets of relearning may be more layers from the identification layer 530 or may include a layer from the feature extraction layer 520. The difference between the two feature amount activity level distributions being within a predetermined range may, for example, be when a magnitude of the difference is less than or equal to a predetermined value, or when the magnitude is greater than or equal to a predetermined value.

The difference between the feature amount activity level distribution of the source domain data 140 and the feature amount activity level distribution of the target domain data 150 may, for example, be a distance between the centers (centroids) of the feature amount activity level distributions, a ratio of overlap of the feature amount activity level distributions, or some other measure.

As described above, the learning device 100 includes a learning target layer determination part 112. When the difference between the feature amount activity level distribution when the first domain data (source domain data 140) is input and the feature amount activity level distribution when the second domain data (target domain data 150) is input is within a predetermined range, only an identification layer 530 of the deep learning model 510 is determined to be the layer to be a target of relearning by the learning target layer determination part 112. When the difference is not within the predetermined range, the identification layer 530 and a layer of the deep learning model 510 that is closer to the input side than the identification layer 530 are determined to be the layers to be a target of relearning by the learning target layer determination part 112.

The learning target layer determination part 112 determines, as layers to be relearned, more layers that are close to the output layer 531, including the identification layer 530 of the deep learning model 510, as a degree by which the difference falls outside of the predetermined range becomes greater.

### Controller: Relearning Part

The relearning part 113 performs relearning of the layer that is the relearning target and is included in the deep learning model 510, using the training data in the target domain data 150. Specifically, the relearning part 113 adjusts (optimizes so as to increase identification accuracy) a parameter related to a layer that is the relearning target and is included in the deep learning model 510.

As described above, the learning device 100 includes the relearning part 113 that performs relearning, using the second domain data (target domain data 150), of the deep learning model 510 that has undergone learning using the first domain data (the source domain data 140).

### Controller: Display Control Part

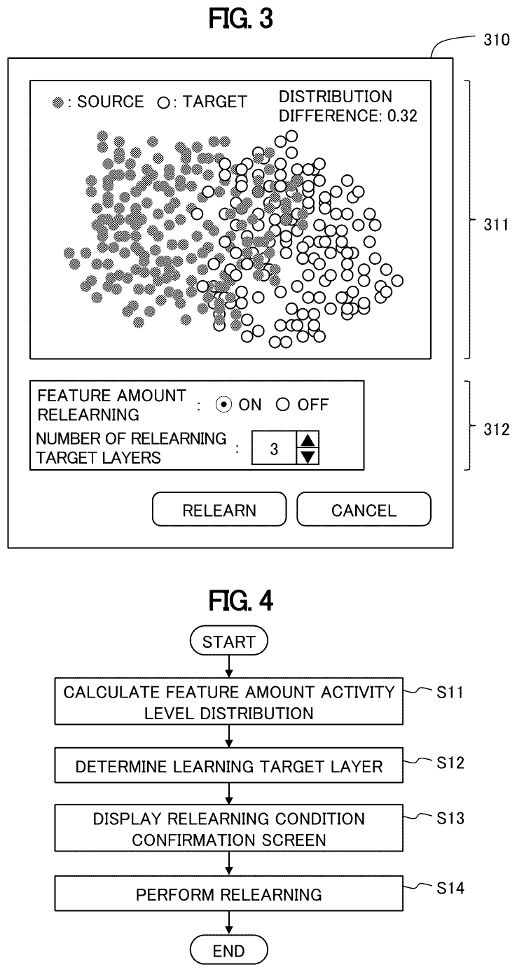

The display control part 114 displays a relearning condition confirmation screen 310 (see FIG. 3 described later) on a display connected to the input/output part 180. FIG. 3 is a configuration diagram of a relearning condition confirmation screen 310 according to the first embodiment. An area 311 displays the feature amount activity level distribution of the source domain data 140, the feature amount activity level distribution of the target domain data 150, and the difference between the two distributions (a distribution difference). In an area 312, a relearning condition is displayed. The relearning condition in FIG. 3 is that relearning is to be executed with three layers including the output layer 531 (in the case of FIG. 2, the output layer 531 and the layers 541 and 542) as relearning target layers. When a user of the learning device 100 is to perform relearning under this condition, the user presses the “Relearn” button. The user may change the number of relearning target layers before pressing the “Relearn” button.

### Relearning Processing

FIG. 4 is a flowchart of relearning processing according to the first embodiment. The relearning processing will be described with reference to FIG. 4.

In step S11, the feature amount activity level distribution calculation part 111 calculates the feature amount activity level distributions of the source domain data 140 and the target domain data 150.

In step S12, the learning target layer determination part 112 determines a layer of the deep learning model 510 to be a target of relearning based on the two feature amount activity level distributions calculated in step S11.

In step S13, the display control part 114 displays the relearning condition confirmation screen 310 (see FIG. 3).

In step S14, the relearning part 113 relearns the deep learning model 510 on the basis of the relearning condition (refer to the area 312 shown in FIG. 3) and stores the relearned deep learning model 510 in the learning model database 160.

### Feature of Learning Device

The learning device 100 determines a layer that is included in the deep learning model 510 and is to be a relearning target on the basis of a difference between the feature amount activity level distributions of the source domain data 140 and the target domain data 150. Next, the learning device 100 performs relearning (adjustment/optimization of a parameter) of the relearning target layer using training data in the target domain data 150. By using such a learning device 100, a user who is not an expert can efficiently perform relearning adapted to the target domain data 150 of the deep learning model 510.

The effect of improving the identification accuracy of the deep learning model 510 after relearning using the learning device 100 is greater compared to relearning only the identification layer or all the layers without using the learning device 100. The effect of improving the identification accuracy of the deep learning model 510 after relearning using the learning device 100 is great in a case where the amount of training data of the target domain data 150 is smaller than the amount of training data of the source domain data 140 and the data-amount ratio is equal to or less than 1/100, particularly equal to or less than 1/1000.

### Second Embodiment

In the first embodiment, the relearning target layer is determined based on the difference between the feature amount activity level distributions (for the input data) of the source domain data 140 and the target domain data 150. The relearning target layer may be determined based on a difference between feature amounts (nodes of the deep learning model 510) whose activation levels are greater than or equal to a predetermined value due to input data of the source domain data 140 and due to input data of the target domain data 150. The relearning target layer may be determined based on a difference between proportions of the feature amounts whose activation levels are greater than or equal to a predetermined value due to input data of the source domain data 140 and due to input data of the target domain data 150.

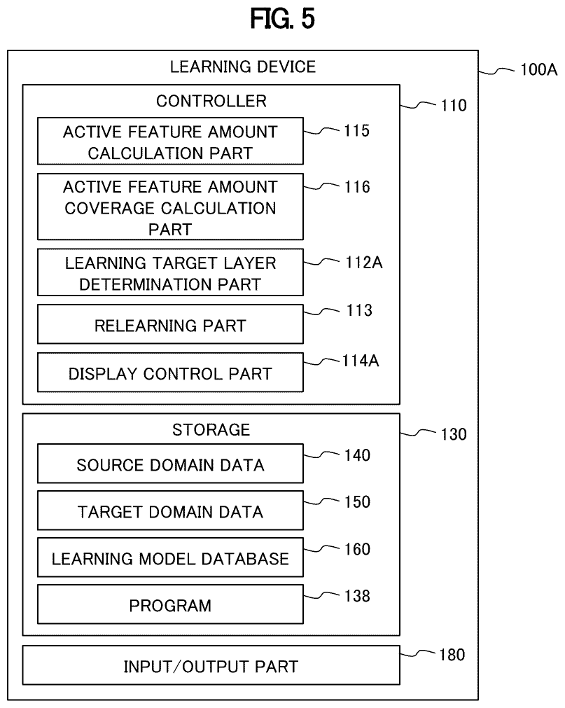

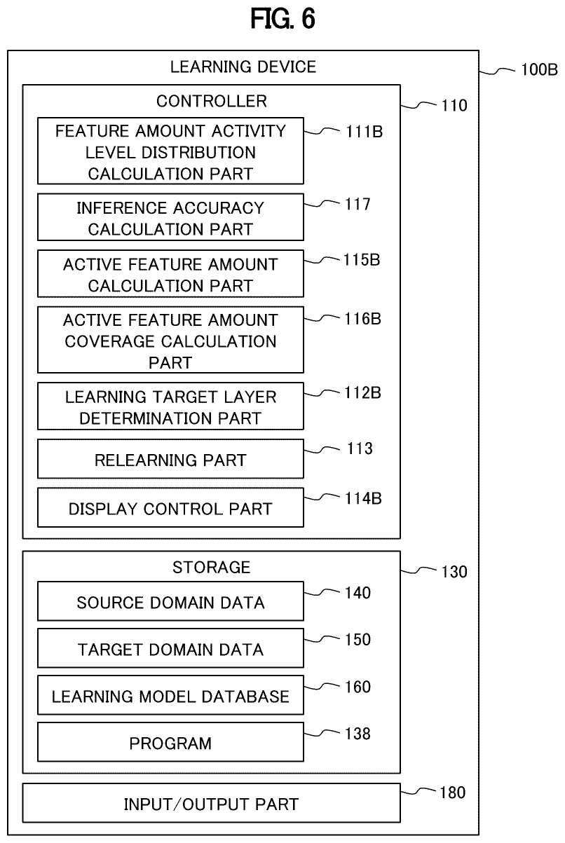

FIG. 5 is a functional block diagram of a learning device 100A according to a second embodiment. Compared with the learning device 100 (see FIG. 1) according to the first embodiment, a controller 110 of the learning device 100A includes an active feature amount calculation part 115, an active feature amount coverage calculation part 116, a learning target layer determination part 112A, and a display control part 114A instead of the feature amount activity level distribution calculation part 111, the learning target layer determination part 112, and the display control part 114.

### Second Embodiment: Active Feature Amount Calculation Part

The active feature amount calculation part 115 calculates a set of nodes (also referred to as an activated feature amount) that are included in the feature amount calculation target layer of the deep learning model 510 and whose activity levels become equal to or greater than a predetermined value by input data. The set of nodes is calculated for the input data in the source domain data 140 and for the input data in the target domain data 150. The active feature amount calculation part 115 calculates, for example, a set of nodes that have been activated to a predetermined value or greater when any input data of the source domain data 140 is input. The feature amount calculation target layer is the same as the feature amount calculation target layer according to the feature amount activity level distribution calculation part 111 according to the first embodiment.

As described above, the learning device 100A includes an active feature amount calculation part 115 that calculates an activated feature amount that is a set of nodes included in a predetermined layer of the deep learning model 510 whose levels of activation by inputted domain data (the source domain data 140, the target domain data 150) are equal to or greater than a predetermined value.

### Second Embodiment: Active Feature Amount Coverage Calculation Part

The active feature amount coverage calculation part 116 calculates a proportion (also referred to as a coverage) of nodes included in a feature amount calculation target layer of the deep learning model 510 whose activity levels by input data are equal to or greater than a predetermined value to all of the nodes included in the feature amount calculation target layer. The proportion is calculated for the input data in the source domain data 140 and for the input data in the target domain data 150. The active feature amount coverage calculation part 116 calculates, for example, a proportion of a set of nodes that have been activated to a predetermined value or greater when any input data of the source domain data 140 is input. The feature amount calculation target layer is the same as the feature amount calculation target layer according to the feature amount activity level distribution calculation part 111 according to the first embodiment.

As described above, the learning device 100A includes an active feature amount coverage calculation part 116 that calculates a coverage that is a proportion of nodes included in a predetermined layer of the deep learning model 510 whose levels of activation by inputted domain data (the source domain data 140, the target domain data 150) are equal to or greater than a predetermined value, to the nodes included in the predetermined layer.

### Second Embodiment: Learning Target Layer Determination Part, Display Control Part

The learning target layer determination part 112A determines a layer of the deep learning model 510 (see FIG. 2) to be a target of relearning based on the activated feature amount of the source domain data 140 and the activated feature amounts of the target domain data 150. More specifically, if a difference between the two activated feature amounts is within a predetermined range, the learning target layer determination part 112A only sets a layer included in the identification layer 530 as the relearning target. If the difference is outside the predetermined range, the learning target layer determination part 112A sets more layers toward the input side, starting from the layer 541, as the relearning target. The layers to be relearned may be more layers of the identification layer 530 or may further include a layer of the feature extraction layer 520. The difference between the two activated feature amounts being within a predetermined range may, for example, be when a magnitude of the difference is less than or equal to a predetermined value, or when the magnitude is greater than or equal to a predetermined value.

Furthermore, the learning target layer determination part 112A may determine a layer of the deep learning model 510 to be a target of relearning based on a coverage (by the input data) of the source domain data 140 and a coverage of the target domain data 150. More specifically, if a difference between the two coverages is within a predetermined range, the learning target layer determination part 112A only sets a layer included in the identification layer 530 as a relearning target. If the difference is outside the predetermined range, the learning target layer determination part 112 sets more layers starting from the output layer 531 toward the input side as targets of relearning. The layers to be targets of relearning may be more layer(s) of the identification layer 530 or may include a layer of the feature extraction layer 520. The difference between the two coverages being within the predetermined range may, for example, be when a magnitude of the difference is less than or equal to a predetermined value or when the magnitude is greater than or equal to a predetermined value.

As described above, the learning target layer determination part 112A may determine a target layer of relearning as follows. If a difference between the activated feature amount when the first domain data (source domain data 140) is input and the activated feature amount when a second domain data (target domain data 150) is input is within a predetermined range, only an identification layer of the deep learning model 510 is determined as the layer to be a target of relearning. If the difference is not within the predetermined range, the identification layer of the deep learning model 510 and a layer closer to the input side than the identification layer are determined as the layers to be a target of relearning.

In another embodiment, the learning target layer determination part 112A may determine a target layer of relearning as follows. If a difference between the coverage when the first domain data is input and the coverage when the second domain data is input is within a predetermined range, only an identification layer of the deep learning model 510 is determined as a target layer to be relearned. If the difference is not within the predetermined range, the identification layer of the deep learning model 510 and a layer of the deep learning model 510 that is closer to the input side than the identification layer are determined as target layers to be relearned.

The learning target layer determination part 112A determines, as the layers to be targets of relearning, a greater number of layers including the identification layer 530 of the deep learning model 510 that are close to the output layer 531 as the degree of deviation of the difference from the predetermined range increases.

In another embodiment, the learning target layer determination part 112A may determine the layer of the deep learning model 510 to be relearned based on both the activated feature amounts and the coverages.

The display control part 114A displays the difference in the activated feature amounts or the coverages in the area 311 (see FIG. 3) instead of the feature amount activity level distribution.

### Second Embodiment: Feature of Learning Device

The learning device 100A determines a layer that is included in the deep learning model 510 and is to be a relearning target based on a difference between the activated feature amounts of the source domain data 140 and the target domain data 150 or between the coverages of the source domain data 140 and the target domain data 150. Efficient relearning is enabled even when a relearning target layer is determined based not on the difference in feature amount activity level distributions but on the difference in activated feature amounts or difference in coverages.

### Third Embodiment

The relearning target layer may be determined in accordance with a change in the deep learning model 510 that occurs after relearning with an increase in the amount of training data. Relearning performed in advance to determine the learning target layer in a third embodiment is relearning that targets the output layer 531 or the identification layer 530 and uses the training data in the target domain data 150. The relearning part 113 performs relearning a plurality of times while changing the amount of training data, for example, 10, 20, and 30 pieces of training data, to generate a plurality of deep learning models 510 that have undergone relearning. A learning device 100B (see FIG. 6 described later) according to the third embodiment determines the learning target layer by using these plurality of deep learning models 510.

FIG. 6 is a functional block diagram of the learning device 100B according to the third embodiment. Compared to the learning device 100 according to the first embodiment, a controller 110 of the learning device 100B includes a feature amount activity level distribution calculation part 111B, an inference accuracy calculation part 117, an active feature amount calculation part 115B, an active feature amount coverage calculation part 116B, a learning target layer determination part 112B, and a display control part 114B instead of the feature amount activity level distribution calculation part 111, the learning target layer determination part 112, and the display control part 114.

### Third Embodiment: Feature Amount Activity Level Distribution Calculation Part, Inference Accuracy Calculation Part, Active Feature Amount Calculation Part, Active Feature Amount Coverage Calculation Part

The feature amount activity level distribution calculation part 111B calculates a feature amount activity level distribution for the target domain data 150 in the deep learning model 510 after relearning.

The inference accuracy calculation part 117 calculates, for the target domain data 150, inference accuracy of the deep learning model 510 after relearning.

The active feature amount calculation part 115B calculates an activated feature amount for the target domain data 150 in the deep learning model 510 after relearning.

The active feature amount coverage calculation part 116B calculates a coverage for the target domain data 150 in the deep learning model 510 after relearning.

As described above, the learning device 100B includes a feature amount activity level distribution calculation part 111B that calculates a feature amount activity level distribution that is a distribution of activity levels of nodes included in a predetermined layer of the deep learning model 510 based on the second domain data (the target domain data 150).

The learning device 100B includes an inference accuracy calculation part 117 that calculates an inference accuracy for the second domain data by the deep learning model 510 after relearning.

The learning device 100B includes an active feature amount calculation part 115B that calculates an activated feature amount that is a set of nodes included in a predetermined layer of the deep learning model 510 and whose levels of activation by the second domain data are equal to or greater than a predetermined value.

The learning device 100B includes an active feature amount coverage calculation part 116B that calculates a coverage that is a proportion of nodes that are included in a predetermined layer of the deep learning model 510 and whose levels of activation by the second domain data are equal to or greater than a predetermined value, to nodes included in the predetermined layer.

### Third Embodiment: Learning Target Layer Determination Part

The learning target layer determination part 112B determines a layer of the deep learning model 510 to be the target of relearning based on an amount of change to the feature amount activity level distribution, the inference accuracy, the active feature amount, or the coverage of the deep learning model 510 after prior relearning due to an increase in the amount of training data. More specifically, the learning target layer determination part 112B sets only a layer included in the identification layer 530 as the target of relearning if the amount of change due to an increase in the amount of training data is within a predetermined range. If the amount of change is outside the predetermined range, the learning target layer determination part 112B sets a greater number of layers as relearning targets, selecting as targets a layer starting from the output layer 531 and more toward the input side. The layers that are targets for relearning may be more layers from the identification layer 530 or may include a layer from the feature extraction layer 520. The amount of change being within the predetermined range may, for example, be when the amount of change is greater than or equal to a predetermined value or less than or equal to a predetermined value.

Note that relearning of the deep learning model 510 when an amount of change of the feature amount activity level distribution, the inference accuracy, the active feature amount, or coverage is calculated is relearning that targets the output layer 531 or the identification layer 530.

As described above, the learning target layer determination part 112B may determine a layer to be a target of relearning as follows. If the amount of change in the feature amount activity level distribution, inference accuracy, active feature amount, or coverage with an increase in the amount of data of the second domain data (target domain data 150) used to relearn the identification layer 530 of the deep learning model 510 is within a predetermined range, only the identification layer of the deep learning model 510 is determined as a layer to be the target of relearning. If the amount of change is outside the predetermined range, the identification layer of the deep learning model 510 and a layer closer to the input side than the identification layer are determined as layers to be the target of relearning.

Furthermore, if the amount of change is outside the predetermined range, the learning target layer determination part 112B determines, as layers to be the target of relearning, more layers that are close to the output layer 531 and are closer to the input side than the identification layer of the deep learning model 510 as a deviation of the amount of change from the predetermined range increases (a distance from the predetermined range becomes greater).

### Third Embodiment: Display Control Part

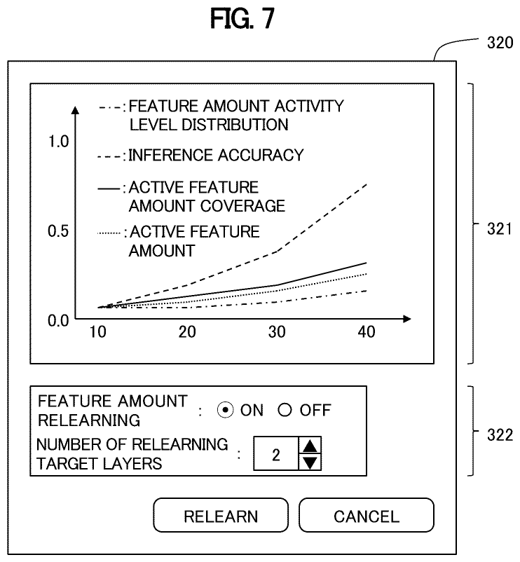

The display control part 114B displays a relearning condition confirmation screen 320 (see FIG. 7 described later) on a display connected to the input/output part 180. FIG. 7 is a configuration diagram of a relearning condition confirmation screen 320 according to the third embodiment. In the area 321, a graph showing a training data amount of the target domain data 150 and changes in the feature amount activity level distribution, the inference accuracy, the coverage (described in FIG. 7 as active feature amount coverage), and the active feature amount of the deep learning model 510 after relearning using training data of the training data amount. In the area 322, a relearning condition is displayed. A user references the graph displayed in the area 321, sets the relearning condition, and instructs relearning.

### Relearning Processing

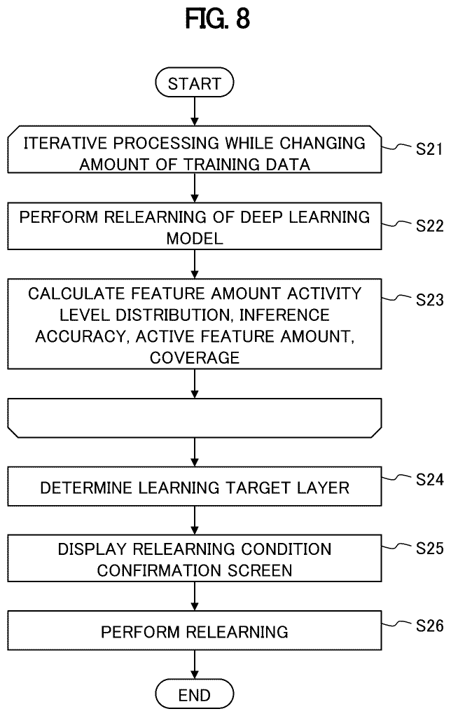

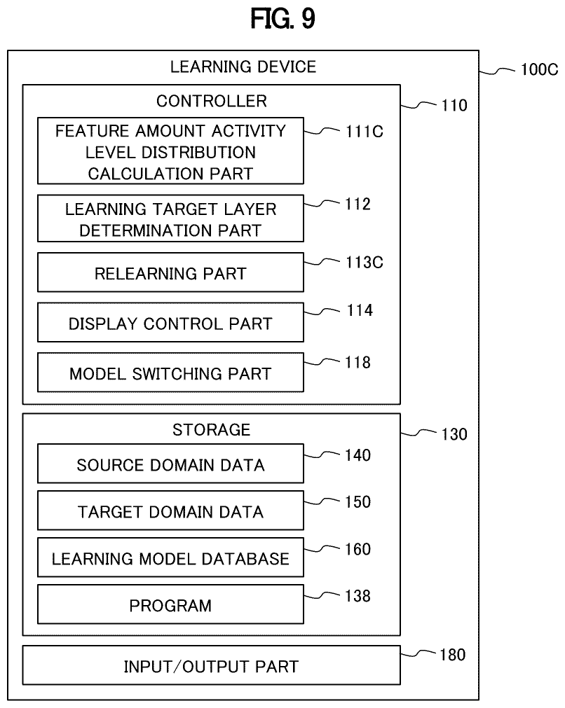

FIG. 8 is a flowchart of relearning processing according to the third embodiment. The relearning processing will be described with reference to FIG. 8.

In step S21, the relearning part 113 selects a plurality of predetermined numbers of pieces of training data from the training data in the target domain data 150, and starts processing of repeating steps S22 and S23 for each of the plurality of predetermined numbers of selected pieces of training data. The plurality of predetermined numbers are, for example, 10, 20, and 30.

In step S22, the relearning part 113 performs (prior) relearning of the deep learning model 510 using a predetermined number of pieces of training data. The relearned deep learning model 510 is stored in the learning model database 160.

In step S23, the feature amount activity level distribution calculation part 111B, the inference accuracy calculation part 117, the active feature amount calculation part 115B, and the active feature amount coverage calculation part 116B calculate the feature amount activity level distribution, the inference accuracy, the active feature amount, and the coverage of the target domain data 150 in the deep learning model 510 after relearning of step S22, respectively.

In step S24, the learning target layer determination part 112B determines the layer of the deep learning model 510 to be relearned, based on the amounts of change in the feature amount activity level distribution, the inference accuracy, the active feature amount, and the coverage calculated in step S23 with an increase in the amount of training data (e.g., 10, 20, 30 pieces of training data).

In step S25, the display control part 114 displays the relearning condition confirmation screen 320 (see FIG. 7).

In step S26, the relearning part 113 relearns the deep learning model 510 on the basis of the relearning condition (see the area 322 described in FIG. 7), and stores the deep learning model 510 that has been relearned in the learning model base 160.

### Third Embodiment: Feature of Learning Device

For relearning of the deep learning model 510 using the training data in the target domain data 150, the learning device 100B determines the layer of the deep learning model 510 to be a target of relearning based on an amount of change in the feature amount activity level distribution, the inference accuracy, the activate feature amount, or the coverage with an increase in the amount of training data used for relearning. Efficient relearning is possible even when the relearning target layer is determined based not on the feature amount activity level distribution but on the amount of change in the inference accuracy or the like with an increase in the amount of training data.

For example, a case is considered in which the amount of change in the inference accuracy or the active feature amount of the deep learning model 510 is large when relearning only the identification layer 530 in prior relearning while increasing the pieces of training data in the target domain data 150 from 10 to 20 and to 30. Then, when the number of pieces of training data is increased thereafter, the learning device 100B continues relearning of only the identification layer 530 using the increased number of pieces of training data. If the amount of change is small, the learning device 100 performs relearning by including more layers, for example, the feature extraction layer 520.

### Fourth Embodiment

In the above-described embodiment, the relearning part 113 performs relearning of a layer that is a relearning target and is included in the deep learning model 510 using the training data in the target domain data 150. In one or more embodiments, depending on a condition, a deep learning model may be newly generated instead of performing relearning. For example, if there is a predetermined number or more of pieces of training data in the target domain data 150, a deep learning model may be newly generated using the training data.

FIG. 9 is a functional block diagram of a learning device 100C according to a fourth embodiment. Compared to the learning device 100 (see FIG. 1), the learning device 100C further includes a model switching part 118. Furthermore, the learning device 100C includes a feature amount activity level distribution calculation part 111C and a relearning part 113C that are different from those of the learning device 100.

If the number of pieces of training data in the target domain data 150 is equal to or greater than a predetermined number, the model switching part 118 instructs the relearning part 113C to generate a new deep learning model (new model generation). The predetermined number may, for example, be 10,000, may preferably be 100,000, and may more preferably be 1,000,000.

In response to the instruction from the model switching part 118, the relearning part 113C generates a new deep learning model using the training data in the target domain data 150.

### Fourth Embodiment: Modification Example

In the fourth embodiment described above, the model switching part 118 instructs the relearning part 113C to generate a new deep learning model when the number of pieces of training data in the target domain data 150 is equal to or greater than a predetermined number. The model switching part 118 may instruct the relearning part 113C to generate a new deep learning model when a difference between the feature amount activity level distributions of the deep learning model 510 before and after relearning is small.

More specifically, the feature amount activity level distribution calculation part 111 calculates feature amount activity level distributions that are distributions of activity levels of nodes included in the feature amount calculation target layer of the deep learning model 510 when input data in the source domain data 140 is input and input data in the target domain data 150 is input. The feature amount activity level distributions are calculated for the deep learning model 510 before relearning and after relearning. When a difference between the feature amount activity level distributions before and after relearning when input data of the target domain data 150 is input is small (within a predetermined range), the model switching part 118 instructs the relearning part 113C to generate a new deep learning model.

The same applies for the activated feature amount. The active feature amount calculation part 115 calculates an activated feature amount that is a set of nodes that are included in the feature amount calculation target layer of the deep learning model 510 and whose activity levels become equal to or greater than a predetermined value by input data. The activated feature amount is calculated for input data in the source domain data 140 and for input data in the target domain data 150. The activated feature amounts are calculated for the deep learning model 510 before relearning and after relearning. When a difference between the active feature amounts before and after the relearning when input data in the target domain data 150 is input is small (within a predetermined range), the model switching part 118 instructs the relearning part 113C to generate a new deep learning model.

Furthermore, the same applies to the activated feature amount coverage. The active feature amount coverage calculation part 116 calculates a coverage that is proportion of nodes that are included in a feature amount calculation target layer of the deep learning model 510 and whose activity levels by input data are equal to or greater than a predetermined value to all of the nodes included in the feature amount calculation target layer. The coverage is calculated for input data in the source domain data 140 and for input data in the target domain data 150. The coverages are calculated for the deep learning model 510 before relearning and after relearning. The model switching part 118 instructs the relearning part 113C to generate a new deep learning model when a difference between the coverages before and after relearning when input data in the target domain data 150 is input is small (within a predetermined range).

Alternatively, the relearning part 113C may be instructed to generate a new deep learning model when the weighted average of the differences in the feature amount activity level distributions, the active feature amounts, and the coverages before and after relearning is small (within a predetermined range).

### Fourth Embodiment: Feature of Learning Device

The learning device 100C according to the fourth embodiment or the modification example thereof generates a new deep learning model when the number of pieces of training data in the target domain data 150 is equal to or greater than a predetermined number or when a difference in the feature amount activity level distributions, activated feature amounts, or coverages before and after relearning is small. In a case where the number of pieces of training data of the target domain data 150 is sufficient, it is expected that a deep learning model suitable for the target domain data 150 may be acquired by newly generating a deep learning model rather than performing relearning. In a case where the difference between the feature amount activity level distributions, the activated feature amounts, or the coverages in the deep learning model before and after relearning is small, the effect of the relearning is low, and it is expected that a deep learning model suitable for the target domain data 150 may be acquired by discarding the relearning and generating a new deep learning model.

### Modification Example

While certain embodiments of the present invention have been described, these embodiments have been presented by way of example only, and are not intended to limit the technical scope of the present invention. In the above description, an image is taken as an example of data areas of the source domain data 140 and the target domain data 150, but the data area may not be limited to an image and may be a text, a moving image, a sound, a voice or the like.

The source domain data 140 includes training data that was used for generating the deep learning model 510, but may not be limited to all of the training data that was used, and may be a part of data to be used for calculating the feature amount activity level distribution, active feature amount, and coverage of the source domain data 140.

The learning target layer determination parts 112 and 112A determine a layer to be a relearning target on the basis of the feature amount activity level distributions, the active feature amounts, and the coverages of the source domain data 140 and the target domain data 150. A basis for determining the layer to be a relearning target is not limited to the feature amount activity level distribution, the active feature amount, and the coverage. The layer to be a relearning target may be determined based on nodes (feature amounts) of the deep learning model 510 that are activated by input data of the source domain data 140 and input data of the target domain data 150.

As described above, the learning target layer determination parts 112 and 112A determine a layer of the deep learning model 510 to be relearned based on nodes that are included in a layer of the deep learning model 510 and are activated by first domain data (source domain data 140) or nodes that are included in a layer of the deep learning model and are activated by second domain data (target domain data 150).

Various other embodiments may be possible according to the present invention. Various changes such as omission or substitution of a component, part or the like may be made without departing from the scope and of the present invention. These embodiments and modifications thereof are included in the scope and gist of the invention described in the present specification and the like, and are also included in the inventions described in the claims and the scope of equivalents thereof.

### Reference Signs List

100, 100A, 100B Learning device
111, 111B, 111C Feature amount activity level distribution calculation part
112, 112A, 112B Learning target layer determination part
113, 113C Relearning part
114, 114A, 114B Display control part
115, 115B Active feature amount calculation part
116, 116B Active feature amount coverage calculation part
117 Inference accuracy calculation part
118 Model switching part
140 Source domain data
150 Target domain data
160 Learning model database
138 Program
310, 320 Relearning condition confirmation screen
510 Deep learning model
520 Feature extraction layer
530 Identification layer
531 Output layer

What is claimed is:

1. A learning device, comprising:
a hardware processor, wherein
the hardware processor is configured to:
cause a deep learning model that has been learned using first domain data to perform relearning using second domain data; and
determine a layer of the deep learning model to be a target of the relearning based on nodes that are included in a layer of the deep learning model and activated by the first domain data or nodes that are included in a layer of the deep learning model and activated by the second domain data.

2. The learning device according to claim 1, wherein
the hardware processor is configured to:
calculate a feature amount activity level distribution that is a distribution of activity levels of nodes according to inputted domain data, the nodes being included in a predetermined layer of the deep learning model;
determine, in response to a difference between the feature amount activity level distribution when the first domain data is input and the feature amount activity level distribution when the second domain data is input being within a predetermined range, only an identification layer of the deep learning model as the layer to be the target of the relearning; and
determine, in response to the difference not being within the predetermined range, the identification layer and a layer of the deep learning model that is closer to an input side than the identification layer as the layer to be the target of the relearning.

3. The learning device according to claim 1, wherein
the hardware processor is configured to:
calculate an activated feature amount that is a set of nodes that are included in a predetermined layer of the deep learning model and whose activation levels according to inputted domain data are greater than or equal to a predetermined value;
determine, in response to a difference between the activated feature amount when the first domain data is input and the activated feature amount when the second domain data is input being within a predetermined range, only an identification layer of the deep learning model as the layer to be the target of the relearning; and
determine, in response to the difference not being within the predetermined range, the identification layer and a layer of the deep learning model that is closer to an input side than the identification layer as the layer to be the target of the relearning.

4. The learning device according to claim 1, wherein
the hardware processor is configured to:
calculate a coverage that is a proportion of nodes that are included in a predetermined layer of the deep learning model and whose activation levels according to inputted domain data are greater than or equal to a predetermined value to nodes included in the predetermined layer;
determine, in response to a difference between the coverage when the first domain data is input and the coverage when the second domain data is input being within a predetermined range, only an identification layer of the deep learning model as the layer to be the target of the relearning; and
determine, in response to the difference not being within the predetermined range, the identification layer and a layer of the deep learning model that is closer to an input side than the identification layer as the layer to be the target of the relearning.

5. The learning device according to claim 2, wherein
the hardware processor is configured to determine that, the greater a degree by which the difference falls outside the predetermined range is, the more layers of the deep learning model that are close to an output layer, including the identification layer, are to be the layer to be the target of the relearning.

6. The learning device according to claim 2, wherein
the hardware processor is configured to display a relearning condition confirmation screen on which the difference and a number of the layers to be the target of the relearning are indicated.

7. The learning device according to claim 1, wherein
the hardware processor is configured to:
calculate a feature amount activity level distribution that is a distribution of activity levels of nodes according to the second domain data, the nodes being included in a predetermined layer of the deep learning model;
determine, in response to an amount of change in the feature amount activity level distribution with an increase in a data amount of the second domain data used to relearn an identification layer of the deep learning model being within a predetermined range, only the identification layer of the deep learning model as the layer to be the target of the relearning; and
determine, in response to the amount of change not being within the predetermined range, the identification layer and a layer of the deep learning model that is closer to an input side than the identification layer as the layer to be the target of the relearning.

8. The learning device according to claim 1, wherein
the hardware processor is configured to:
calculate an inference accuracy of the deep learning model after the relearning regarding second domain data;
determine, in response to an amount of change in the inference accuracy with an increase in a data amount of the second domain data used to relearn an identification layer of the deep learning model being within a predetermined range, only the identification layer of the deep learning model as the layer to be the target of the relearning; and
determine, in response to the amount of change not being within the predetermined range, the identification layer and a layer of the deep learning model that is closer to an input side than the identification layer as the layer to be the target of the relearning.

9. The learning device according to claim 1, wherein
the hardware processor is configured to:
calculate an activated feature amount that is a set of nodes that are included in a predetermined layer of the deep learning model and whose activation levels according to the second domain data are greater than or equal to a predetermined value;
determine, in response to an amount of change in the activated feature amount with an increase in a data amount of the second domain data used to relearn an identification layer of the deep learning model being within a predetermined range, only the identification layer of the deep learning model as the layer to be the target of the relearning; and
determine, in response to the amount of change not being within the predetermined range, the identification layer and a layer of the deep learning model that is closer to an input side than the identification layer to be the layer to be the target of the relearning.

10. The learning device according to claim 1, wherein
the hardware processor is configured to:
calculate a coverage that is a proportion of nodes that are included in a predetermined layer of the deep learning model and whose activation levels according to the second domain data are greater than or equal to a predetermined value to nodes included in the predetermined layer;
determine, in response to an amount of change in the coverage with an increase in a data amount of the second domain data used to relearn an identification layer of the deep learning model being within a predetermined range, only the identification layer of the deep learning model as the layer to be the target of the relearning; and
determine, in response to the amount of change not being within the predetermined range, the identification layer and a layer of the deep learning model that is closer to an input side than the identification layer as the layer to be the target of the relearning.

11. The learning device according to claim 7, wherein
when the amount of change is not within the predetermined range, the hardware processor is configured to determine that the greater a degree by which the amount of change falls outside the predetermined range is, the more layers of the deep learning model that are closer to the input side than the identification layer and close to an output layer are to be the layer to be the target of the relearning.

12. The learning device according to claim 1, wherein
a data amount of the second domain data is equal to or less than 1/100 of a data amount of the first domain data.

13. A non-transitory recording medium storing a computer readable program for causing a computer to perform operations comprising:
causing a deep learning model that has been learned using first domain data to perform relearning using second domain main data; and
determining a layer of the deep learning model to be a target of the relearning based on nodes that are included in a layer of the deep learning model and activated by the first domain data or nodes that are included in a layer of the deep learning model and activated by the second domain data.

14. A learning method performed by a learning device, the learning method comprising:
causing a deep learning model that has been learned using first domain data to perform relearning using second domain data; and
determining a layer of the deep learning model to be a target of the relearning based on nodes that are included in a layer of the deep learning model and activated by the first domain data or nodes that are included in a layer of the deep learning model and activated by the second domain data.
